(19) United States
(12) Patent Application Publication
(10) Pub. No.: US 2011/0102829 A1
(43) Pub. Date: May 5, 2011

(54) IMAGE SIZE WARNING

(76) Inventor: Arlene T. Jourdan, Rochester, NY (US)

(21) Appl. No.: 12/609,153

(22) Filed: Oct. 30, 2009

(51) Int. Cl. G06K 15/00; G06K 15/02

(52) U.S. Cl. 358/1.14; 358/1.2

(57) ABSTRACT

A method of detecting and indicating to a user of an application for image printing that an image is unsuitable for printing. Unsuitability for printing of an image typically will be triggered when print size and image resolution are mismatched. Novel user interface algorithms assist the user to correctly modify an image in order to satisfy suitability requirements.

### FIELD OF THE INVENTION

The present invention pertains to the field of image printing. More particularly, the present invention pertains to the resolution of a detected inadequate image resolution for a selected print size.

### BACKGROUND OF THE INVENTION

For digital image printing there is a threshold print size which becomes unsuitable for an existing digital image file resolution. This is generally determined by the relative number of pixels used to capture the image. If a captured image has too few pixels for a selected print size, individual pixels appear in the digital image print, i.e. the image becomes “pixellated” by displaying geometric rectangular contours within the image.

Once a selected image is placed in an image node and found to be unsuitable, it has been difficult to convey to the user what aspect of the image has made the image unsuitable or how to resolve this issue. It could be unsuitable due to either crop/zooming, or the original image could be unsuitable for a particular image node for another reason. Typically, the user receives a warning that the image is not recommended for the image node size it is in. Current software provides a warning indicating only that the digital image and node match is unsuitable.

### SUMMARY OF THE INVENTION

The present invention addresses the exact ratio when this inconsistency between capture resolution and requested image print size appears and provides a convenient user interface for handling adjustments to the user requested print size. Portions of the user interface methodology are automatically executed by computer system programming. The exact ratio that determines suitability for printing is a combination of requested print size, for example, print image width by print image height, and captured image size, for example, image pixel count, and is useful in printing both snapshot sized prints as well as collages, photobooks, etc.

Two image adjustment factors that can change the effective printing suitability of a digitally stored image, relative to print size, include cropping and zooming the digital image. For the cropping aspect, the user typically can opt to print only a portion of a digital image. If a user crops a 0.6 megapixel (“MP”) image such that only 0.3 MP of the image is used for print data, then it may no longer be suitable for a 4×6″ print in order to avoid all pixellation of the printed image.

Considering these two methods for adjusting a digital image for formatting a suitable 4×6″ print, it is fairly straightforward for the user, through use of the present invention, to understand what size image is acceptable for a certain size print. Matching captured image resolution to print size, or vice versa, can become complicated when, for example, a user is creating a 8×10″ book and the digital image is one of several digital images to be printed on a page, each image to be disposed at an image node. The present invention allows the user to monitor the suitability of the image's resolution after it is placed in the selected image node.

Therefore, the present invention includes several methods for addressing existing problems in digital image and print size compatibility. First, a user interface that allows a user to visually see an exact point where crop/zoom becomes unacceptable and, therefore, a clear illustration of what is necessary to avoid an incompatibility issue. This is embodied in presenting to a user the original captured image and indicating on the original image the cropped or zoomed area in order to permit the user to reselect the cropped or zoomed area to the user's liking until sufficient resolution is obtained for printing purposes.

A second embodiment is provided that allows a user the option to replace the unsuitable image with another image from a collection of digital images. A third embodiment allows a user to manually operate a cursor controlled sizing bar for adjusting an image size and indicating the point at which a resize becomes acceptable. A fourth embodiment provides a user with an option to reduce a size of an image node instead of reducing a digital image size, so that a current digital image can be disposed in an image node without changing the original image size. A combination of both reducing an image size and reducing the size of an image node can be performed.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications. The figures below are not intended to be drawn to any precise scale with respect to size, angular relationship, or relative position.

### BRIEF DESCRIPTION OF THE DRAWINGS

FIG. 1 is a block diagram of a computer system sufficient for practicing various embodiments of the present invention.

FIG. 2 illustrates a flow chart of a method to avoid printing suitability mismatches.

FIG. 3 illustrates a table of digital print sizes and recommended resolutions.

FIG. 4 illustrates a template of image nodes and a current warning icon.

FIG. 5 illustrates an image with a magnification box.

FIG. 6 illustrates an image indicating that cropping has been performed. FIGS. 7A-7B illustrate an example of a continuous zoom control indicator for controlling and indicating when an image becomes suitable.

FIG. 8 illustrates an example of a list display for indicating options to correct resolution mismatch.

FIGS. 9A-9C illustrate pull down windows of available user options.

### DETAILED DESCRIPTION OF THE INVENTION

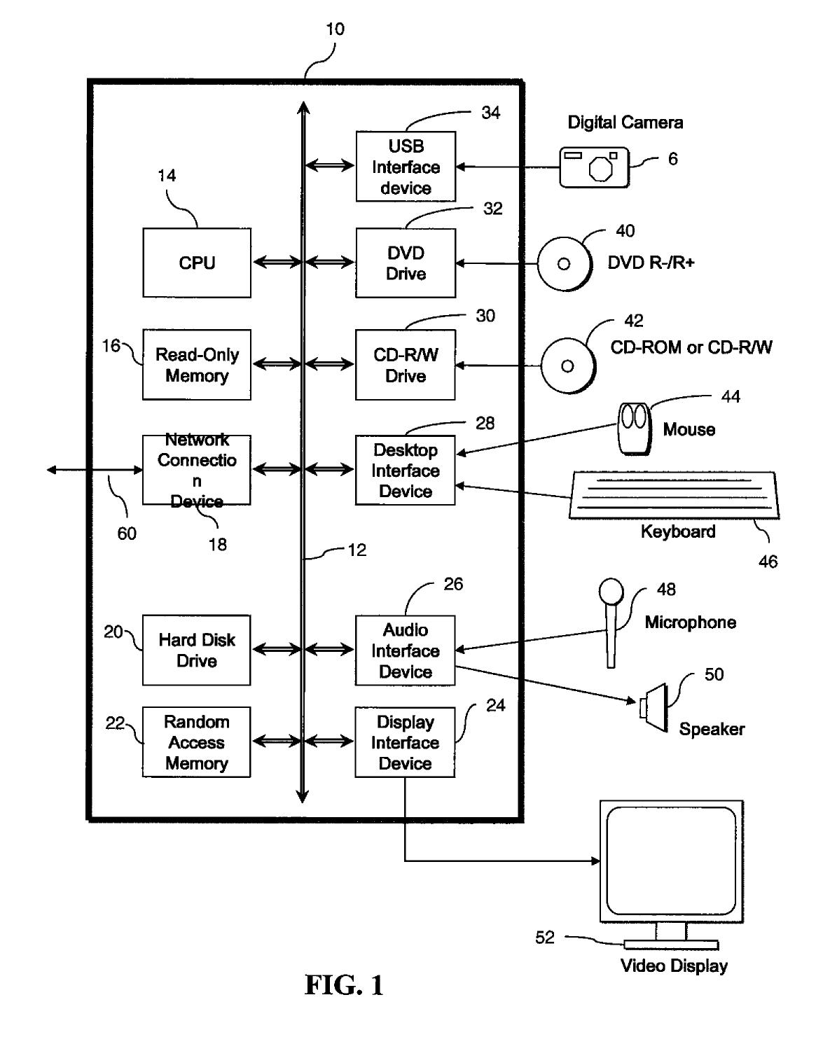

FIG. 1 illustrates one example system for practicing an embodiment of the present invention. In this example, the system includes a computer 10 which typically comprises a keyboard 46 and mouse 44 as input devices communicatively connected to the computer's desktop interface device 28. The term “computer” is intended to include any data processing device, such as a server, desktop computer, a laptop computer, a mainframe computer, a router, a personal digital assistant, a Blackberry, and/or any other device for computing, and/or classifying, and/or processing, and/or transmitting, and/or receiving, and or retrieving, and/or switching, and/or storing, and/or displaying, and/or measuring, and/or detecting, and/or recording, and/or reproducing, and/or utilizing any form of information, intelligence or data for any purpose whether implemented with electrical and/or magnetic and/or optical and/or biological components, and otherwise. The phrase “communicatively connected” is intended to include any type of connection, whether wired, wireless, or both, between devices, and/or computers, and/or programs in which data may be communicated. Further, the phrase “communicatively connected” is intended to include a connection between devices and/or programs within a single computer, a connection between devices and/or programs remotely located in different computers, and a connection between or within devices not located in computers at all.

Output from the computer 10 is typically presented on a video display 52, which may be communicatively connected to the computer 10 via the display interface device 24. Internally, the computer 10 contains components such as CPU 14 and computer-accessible memories, such as read-only memory 16, random access memory 22, and a hard disk drive 20, which may retain some or all of the digital objects referred to herein. The phrase “computer-accessible memory” is intended to include any computer-accessible data storage device, whether volatile or nonvolatile, electronic, magnetic, optical, or otherwise, including but not limited to, floppy disks, hard disks, Compact Discs, DVDs, flash memories, such as USB compliant thumb drives, for example, ROMs, and RAMs.

The CPU 14 communicates with other devices over a data bus 12. The CPU 14 executes software stored on, for example, hard disk drive 20. In addition to fixed media such as a hard disk drive 20, the computer 10 may also contain computer-accessible memory drives for reading and writing data from removable computer-accessible memories. This may include a CD-RW drive 30 for reading and writing various CD media 42 as well as a DVD drive 32 for reading and writing to various DVD media 40. Audio can be input into the computer 10 through a microphone 48 communicatively connected to an audio interface device 26. Audio playback can be heard via a speaker 50 also communicatively connected to an audio interface device 26. A digital camera 6 or other image capture device can be communicatively connected to the computer 10 through, for example, the USB interface device 34 to transfer digital objects from the camera 6 to the computer's hard disk drive 20 and vice-versa. Finally, the computer 10 can be communicatively connected to an external network 60 via a network connection device 18, thus allowing the computer to access digital objects and media assets from other computers, devices, or data-storage systems communicatively connected to the network. A “data-storage system” may include one or more computer-accessible memories, and may be a distributed data-storage system including multiple computer-accessible memories communicatively connected via a plurality of computers, a network, routers, and/or other devices. Alternatively, a data storage system need not be a distributed data-storage system and, consequently, may include one or more computer-accessible memories located within a single computer or device.

A collection of digital objects and/or media assets can reside exclusively on the hard disk drive 20, compact disc 42, DVD 40, or on remote data storage devices, such as a networked hard drive accessible via the network 60. A collection of digital objects can also be distributed across any or all of these storage locations.

A collection of digital objects may be represented by a database that uniquely identifies individual digital objects (e.g., such as a digital image file) and their corresponding location(s). It will be understood that these digital objects can be media objects or non-media objects. Media objects can be digital still images, such as those captured by digital cameras, audio data such as digital music or voice annotations, digital video clips with or without sound. Media objects could also include files produced by graphic or animation software such as those produced by Adobe Photoshop™ or Adobe Flash™. Non-media objects can be text documents such as those produced by word processing software or other office-related documents such as spreadsheets or email. A database of digital objects can be comprised of only one type of object or any combination of objects. Once a collection of digital objects is associated together, such as in a database or by another mechanism of associating data, the objects can be abstractly represented to the user in accordance with an embodiment of the present invention.

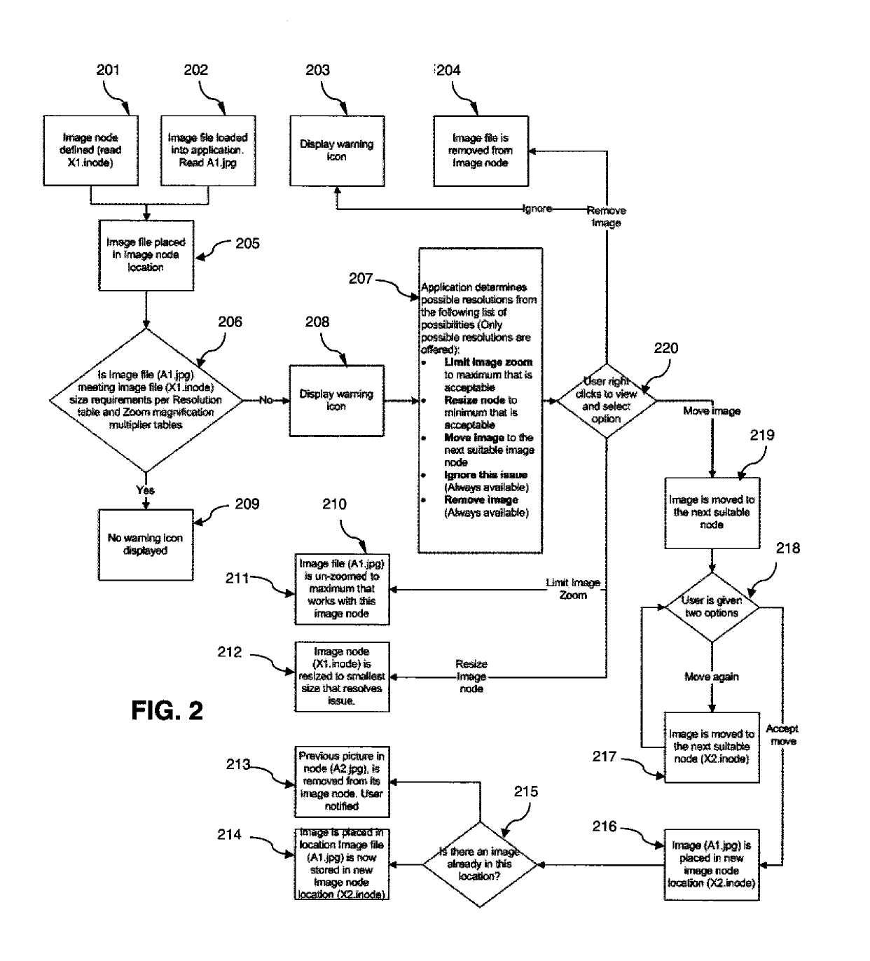

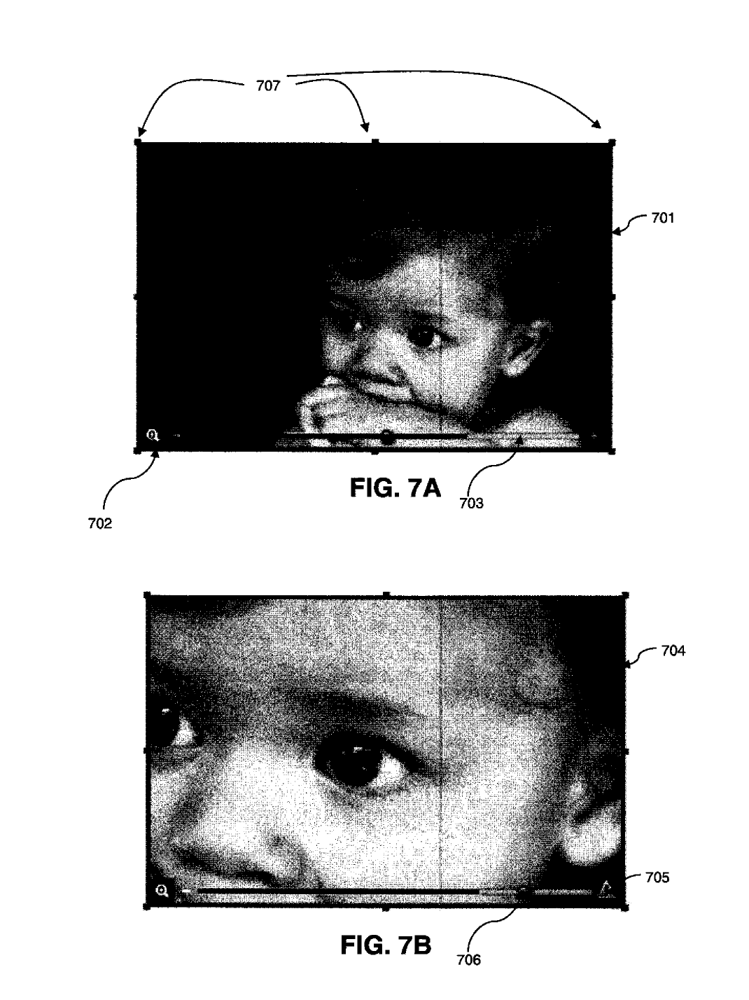

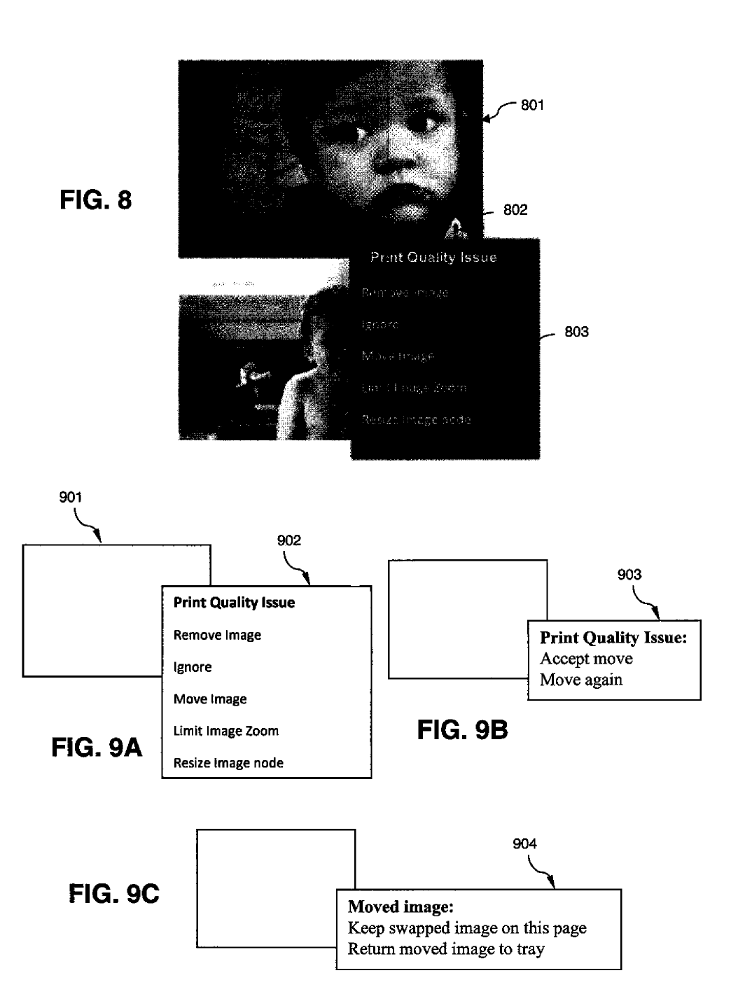

In the case of a user employing a crop/zoom adjustment for a digital image to be printed, we propose the following programmed method of showing where the crop/zoom adjustment takes the image into a poor printing situation and programmed methods of modifying the adjustment to avoid poor printing. With reference to the flowchart of FIG. 2, in steps 210 and 202 the image and image node are selected. The image node is defined as part of a template, for example, such as illustrated in FIG. 4. Various other templates can be designed, such as photobooks, or other objects that can receive digital images to be printed. FIG. 4 illustrates a template 401 having several image nodes, for example, image node 402, for placing digital images. The user selects one of these templates and selects one of the nodes therein, step 201, for placing a selected image, step 202. At step 205 a user selected image is placed in the user selected node, e.g. the center image node of template 401, and the template with the selected image is displayed on display 52. In the example being described, the selected image will result in a poor printing condition being automatically detected by the computer system at step 206, and will be indicated as such automatically, via icon 403, shown in the center image node of template 401, also by operation of the computer system, at step 208, running the program code of the present invention. If the digital image selected for the image node is of sufficient resolution then no warning icon is displayed, step 209. An example of a user selected digital image including the warning icon, is illustrated in FIG. 8 via digital image 801 with displayed warning icon 802.

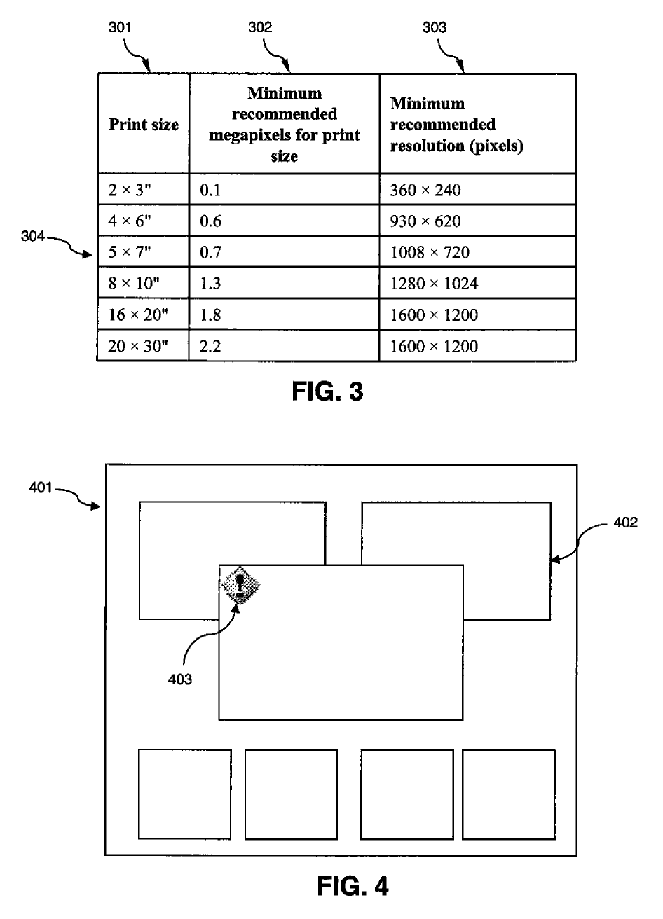

A preferred embodiment of the procedure employed at step 206, to determine whether the selected digital image will result in a poor printing condition, is described with reference to the resolution table illustrated in FIG. 3. The first column of the table 301 illustrates increasing print sizes; the second column shows corresponding resolution requirements of a digital image in total megapixels; while column 3 illustrates recommended pixel by pixel sizes. The table of FIG. 3 is an example table, whereas actual implemented tables can encompass many thousands of cells corresponding to a variety of image sizes and shapes. The upshot of this table is that a printed image will avoid pixellation problems if a selected digital image contains a sufficient number of pixels per unit of printed image area. These calculations can be stored in a table as illustrated, or can be calculated dynamically “on the fly” as users select images and image nodes. More sophisticated computer calculations may consider image content as well as pixel size and perform a more comprehensive evaluation. Regardless, the computer will be able to determine the acceptable image node sizes for selected images. A row of the table corresponding to a selected image node of dimensions 5×7 inches 304 recommends that a selected digital image should have a minimum required 0.7 megapixels of image data to avoid poor printing. This example embodiment will issue a warning icon, step 208, if the selected digital image contains less image data than the recommended minimum amount.

At step 207 a list of options is presented to a user that chooses to correct the detected poor printing condition. The list of options can include a wide variety of programmable options, however, as explained below, the illustrated options are examples. A user can elect to modify a digital image that has triggered a warning icon by clicking on the warning icon 802 using mouse 44 which results in the example drop down menu 803 providing the user with a range of options to address the resolution mismatch condition. The options provided to a user in a preferred embodiment of the present invention are illustrated in FIG. 9A at element 902. The user can activate any of these options, at step 220, by clicking on the list item with computer system mouse 44. The option to “Remove Image” is activated by clicking on the selection 803. This will allow the user to select another image for placement in the image node because the previously selected image will be deleted from the template, in step 204. A second option presented to the user is “Move Image” (or “Move To Resolve”) as shown at step 207 and in list 902. If the user activates this option by selecting it from the list, as above, “Move To Resolve”, is activated, the user selected image will be automatically moved, at step 219, by program from, for example, the center image node of template 401 to an image node in the template that will not result in a mismatch condition, such as image node 402. The new placement of the user selected image will be displayed on display 52, and the program proceeds to step 218, where further options are provided on the display to be selected by the user 903. If the user accepts this new image node location the user can indicate acceptance, at step 216, or the user can activate another move to another program acceptable image node in the template at step 217. If a move to a new image node overwrites an image that was placed there previously, at step 215, the user is notified of the overwrite at step 213, as shown at 904. If the new image node was empty then the image is placed in the new image node at step 214 and the template is displayed on display 52.

If the option “Skip” (or “Ignore”) is activated by the user, then the program will continue displaying the warning icon, at step 203, while further digital image and image node selections are continued by the user or, if a particular template is already complete, then the user can print the completed template even if the warning icons are present. Of course, the warning icons will not appear in the printed product.

If the option “Edit” (or “Limit Image Zoom”) or “Resize Node” is selected by the user, then, at step 211, the user can un-zoom the image until sufficient resolution of image data for the selected image node size becomes available to avoid a poor printing condition or, conversely, at step 212, the user can reduce the size of the image node until sufficient digital image data resolution for the resized image node is achieved. This editing option of resizing a digital image and/or the image node is described as follows.

Upon clicking on the warning icon, at step 220, which, in the illustrated examples herein, contains an exclamation point within a diamond or triangle, 403, 802, the drop down list appears as exemplified in FIG. 8 at 803 and in FIGS. 9A-9C.

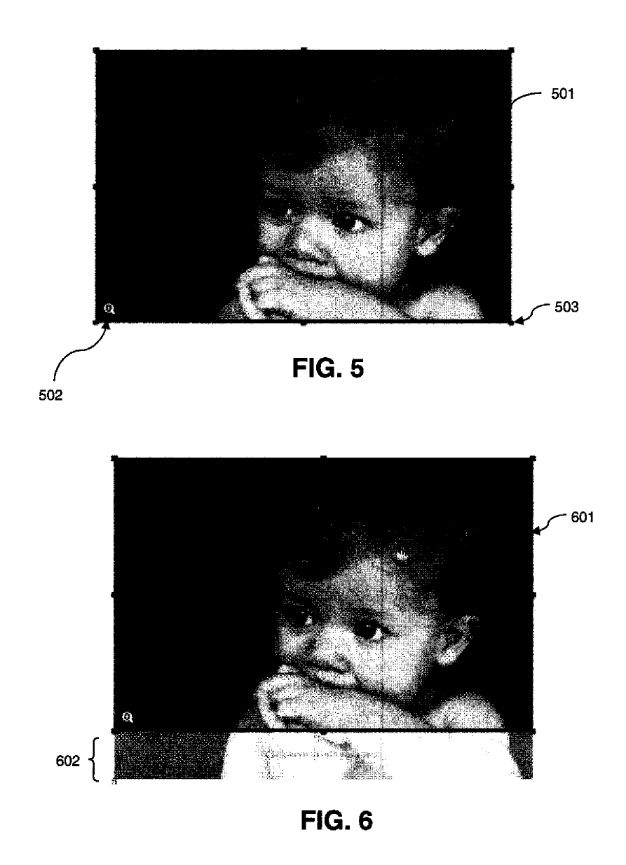

In response to clicking on the image within the node the computer system display will show the digital image 501 as illustrated in FIG. 5 (the example image has been changed from that displayed in FIG. 8). The user then sees a magnifying box 502 displayed on the display, typically a computer monitor 52, indicating that the editing option is available. By placing the cursor is over the image and clicking on, for example, the left mouse button, the rest of the picture is made visible, as shown in FIG. 6. This display 601 indicates that this picture has been cropped 602 to fit into this image node.

By clicking on the magnifying box 502, rather than on the image, the display changes to that shown in FIG. 7A 701 and provides a zoom control including acceptable and unacceptable resolutions indicated by a color bar 703. FIG. 7B illustrates that the color bar slid able cursor 706 has been moved from its position in FIG. 7A, where the color bar slid able cursor was positioned in the sufficient resolution region of the color bar as indicated by its darker color, to a region of the color bar (lighter shaded region) where the level of zoom now makes this image unsuitable to print in this image node. If the image is zoomed to where the cursor is positioned in this lighter colored warning area and left there, the warning symbol 705 would remain on the image when viewed as a template, as exemplified in FIG. 4, indicating that print quality would be sub-optimal if the node size is not reduced. This directly addresses the issue where crop/zoom has made an image unsuitable for printing. The size of the image node can also be optionally adjusted by dragging any of the eight sizing boxes 707 surrounding the image, as is well known. The user can operate either the zoom or node resizing or both to correct a resolution mismatch condition.

hi another preferred embodiment, when the user chooses “Move Image,” the selected digital image is moved to another image node, determined by the application to be a suitable image node, until a new location is accepted by the user. Once it moved to all possible nodes and was not accepted by the user, it would return to original location, where it would remain tagged with the warning symbol. If a user accepts a new location, the digital image would remain at the accepted image node. An optional embodiment includes swapping out the picture and requesting a user indication for approval, or to return the digital image to an image tray.

In another preferred embodiment, if the user chooses Resize node, the image node is reduced in size to an acceptable size that eliminates the warning. Another preferred embodiment includes a Move option where the user could manually moves the photo to a suitable image node. In an optional embodiment, this feature will maintain crop/zoom assuming the user does not want this changed.

The invention has been described in detail with particular reference to certain preferred embodiments thereof, but it will be understood that variations and modifications can be effected within the spirit and scope of the invention.

### PARTS LIST

6 digital camera
10 personal computer
12 data bus
14 CPU
16 read-only memory
18 network connection device
20 hard disk drive
22 random access memory
24 display interface device
26 audio interface device
28 desktop interface device
30 CD-R/W drive
32 DVD drive
34 USB interface device
40 DVD-based removable media such as DVD R- or DVD R+
42 CD-based removable media such as CD-ROM or CD-R/W
44 mouse
46 keyboard
48 microphone
50 speaker
52 video display
60 network
201 step
202 step
203 step
204 step
205 step
206 step
207 step
208 step
209 step
210 step
211 step
212 step
213 step
214 step
215 step
216 step
217 step
218 step
219 step
220 step
301 column
302 column
303 column
304 row
401 template
402 image node
403 icon
501 image
502 magnification box
503 sizing box
601 image
602 crop area
701 image
702 magnification box
703 zoom bar
704 image
705 icon
706 cursor
801 image
802 icon
803 list item
901 image node
902 list
903 list
904 list

1. A computer implemented method of adjusting a digital image for printing comprising:
selecting an image print layout including selecting the digital image;
automatically detecting a mismatch condition between the digital image and an image node in the layout;
automatically generating a warning for indicating the mismatch condition to a user; and
presenting a correction screen to the user for indicating options for correcting the mismatch.

2. The method of claim 1, wherein the step of automatically detecting comprises detecting an insufficient pixel resolution for avoiding pixellation in a printed version of the image print layout that includes the selected digital image.

3. The method of claim 2, wherein the step of presenting further comprises displaying a zoom bar having a slideable cursor and a shaded region indicating an acceptable level of zoom wherein the digital image contains a sufficient number of pixels.

4. The method of claim 2, wherein the step of presenting comprises displaying a zoom bar having a slideable cursor and a point indicating where zooming an image causes a mismatch condition.

5. The method of claim 2, wherein the step of presenting comprises the step of displaying options for correcting the mismatch in a menu of options.

6. The method of claim 2, wherein the step of presenting comprises the step of permitting the user to select a replacement digital image for replacing the digital image.

7. The method of claim 2, wherein the step of automatically detecting further comprises looking up a table of print resolution requirements.

8. A computer implemented method of avoiding printing a pixellated digital image comprising:
receiving a print request including a selected digital image;
automatically comparing a size of a printed version of the selected digital image in the print request with a number of pixels in the digital image;
automatically detecting an insufficient number of pixels in the selected digital image;
automatically displaying a print warning in response to the step of automatically detecting; and
displaying a correction screen for a user to adjust the number of pixels in the selected digital image.

9. The method of claim 8, wherein the step of displaying comprises displaying an original version of the selected digital image.

10. The method of claim 9, wherein the step of displaying further comprises displaying a zoom bar having a slideable cursor and regions wherein the slideable cursor generates sufficient image zoom resolution for printing.

11. The method of claim 9, wherein the step of displaying further comprises the step of displaying options in a menu for adjusting the number of pixels in the selected digital image.

12. The method of claim 8, wherein the step of automatically detecting comprises looking up a table of print resolution requirements.

13. A user interface comprising:
means for the user to select an image template, the image template comprising a plurality of image nodes for placing selected images;
means for the user to select one or more digital images to place in at least one of the image nodes;
means for detecting a mismatch condition between said at least one of the image nodes and said one or more user selected digital images; and
means for presenting on a display a visual depiction of the mismatch condition, the depiction including adjusting means for the user to adjust the digital image for eliminating the mismatch condition.

14. The interface of claim 13, wherein the selected digital image is a cropped image, and the visual depiction includes uncropped portions of the cropped image.

15. The interface of claim 14, wherein the adjusting means includes means for including the uncropped portions in the selected digital image.

16. The interface of claim 13, wherein the selected digital image is a zoomed image, and the visual depiction includes a zoom bar and slideable cursor for unzooming the zoomed image until a sufficient resolution is obtained.

17. The interface of claim 16, wherein the zoom bar includes a shaded region indicating the sufficient resolution when the cursor is moved into the shaded region.

18. The interface of claim 13, wherein the adjusting means includes means for indicating to the user another image node that is not mismatched with the selected digital image.

19. The interface of claim 13, wherein the means for detecting a mismatch condition includes means for detecting an insufficient resolution of the selected digital image.

20. The interface of claim 13, wherein the image template comprises only one image node for placing said one or more digital images.
